(19) United States
(12) Patent Application Publication
(10) Pub. No.: US 2021/0374880 A1
(43) Pub. Date: Dec. 2, 2021

(54) DISTRIBUTED SELF MODERATING SOCIAL COLLABORATION SYSTEM

(71) Applicant: Charles Saron Knobloch, Katy, TX (US)

(72) Inventor: Charles Saron Knobloch, Katy, TX (US)

(21) Appl. No.: 17/336,197

(22) Filed: Jun. 1, 2021

Related U.S. Application Data
(60) Provisional application No. 63/031,770, filed on May 29, 2020.

(51) Int. Cl. G06Q 50/00; H04L 12/58; G06N 20/00; G06K 9/62

(52) U.S. Cl. CPC G06Q 50/01; H04L 51/046; H04L 51/12; G06K 9/6256; H04L 51/26; G06N 20/00; H04L 51/16

(57) ABSTRACT

A distributed network of servers, independently managed from each other, having specialized capability to receive, process, and forward social media moderating and censoring commands. In one example, the moderating and censoring commands are processed by a state machine contained in the special capability servers. Individual users are able to subscribe to more than one server. Individual users are able to choose among a plurality of separate human interfaces or “skins” or apps to meet their social media interface preferences.

### CROSS REFERENCE TO RELATED APPLICATIONS

This application claims the benefit of U.S. Provisional Application No. 63/031,770 of filing date May 29, 2020.

### TECHNICAL FIELD

The examples of the invention provided herein relate to methods and systems for safe communication and assembly of people by electronic collaboration means. In particular, disclosed herein are examples eliminating the centralized serving and the centralized censoring of users seeking to communicate and assemble.

### BACKGROUND OF THE INVENTION

Society has a major problem in electronic social media, in that the electronic platform providers have been censoring people's postings, shadow banning, trolling, tracking, selling personal information and otherwise abusing the freedom of assembly and privacy and freedom of expression of the people in our society. Individuals, entire groups of people, and even presidents are being prohibited from collaborating with others and with each other. Media platform owners can do these things because the messaging between people is brokered, stored, and managed by servers under the control of the media platform owners.

As technology has matured, there is no longer a reason to have a centralized owner who controls the servers. In effect, most current social media platforms are commercially “dead men walking”. Once a de-centralized server or server-less platform becomes popular, these traditional companies will no longer have a viable commercial business model in which to operate. There is an ongoing effort to bring governments into the fray to establish electronic social media regulations. This, however, is a Trojan horse, with designs and desires to electronically regulate the social industry to prevent new players and new technologies from usurping the classical centralized control of social media platforms. By analogy, this is similar to the historic radio industry, where regulation enabled and enables a few networks to control commercial radio and television broadcasting.

There are and have been numerous attempts to create de-centralized social media platforms that do not rely on centralized brokering and storing of user communications. These run into latency and bandwidth restraints, due to the need to make many internet socket connections and dynamic addressing to locate the decentralized servers. Communication failures are frequent and the network is fragile. Another disadvantage is that at least some of the users must be technically skilled to install server-type technology on their local machines (desktops, smartphones, etc). The millions-to-millions connectivity that is required to replace the centralized servers of traditional social media renders the current alternate technology techniques impractical.

Current, traditional social media platforms enjoy the benefit of having thousands or even millions of subscribers, worldwide. They control the equivalent of a global phone book for a worldwide telephone exchange. This forms a daunting barrier to entry for new social media companies and/or new social media technologies. So, another technological problem that must be overcome is to be able to introduce a new social media technology that will work for its subscribers without the immediate need for global connectivity to millions of subscribers.

Further, social media subscribers are forced to use their social media platform through a single type of user interface. For instance, when a subscriber is subscribed to FaceBook, they and every other subscriber use the same or very similar user interface. What is needed in society is the ability to electronically assemble and communicate with others, even if the users do not share the same user interface. There is a need for specialized human user interfaces that are tailored to the user's individual preferences and affinities.

There is a long felt need for a distributed social network platform that is capable of having different user interfaces to match the needs and desires of different users. There is also the long felt need to remove a single entity from e-communication and e-assembly control. There is also a long felt need to have a stable, reliable, and fast method of transferring communications and collaborative assembly between users.

### BRIEF DESCRIPTION OF THE SEVERAL DRAWINGS

FIG. 1 illustrates a schematic diagram of a human interface device (HID) that is in communication with a hosted specialized server (HSS). The HSS is under the command and control of the user of the HID.

FIG. 2 illustrates a schematic diagram of three HID that are in communication with an HSS. Communication of two of the HID's with the HSS are under the management of the one HID that commands and controls the HSS.

FIG. 3 illustrates a schematic diagram of two HSS's in communication with each other. Three HID are in communication with one HSS and one HID is in communication with the other HSS. One HID is in controlling communication with its respective HSS and is also in subservient communication with the other HSS that is controlled by another HID.

FIG. 4 illustrates a schematic diagram of a network of HSS's and HID's and the routing table/state machine of one HSS.

### DETAILED DESCRIPTION OF THE INVENTION

Disclosed herein are descriptions of various examples of the invention. In this description, a “hosted specialized server” is used to describe a hosting server that performs the regulation and communication functions herein described.

In one example, a new user subscribes or otherwise downloads a social media interface for them to enjoy communicating and assembling with others through electronic communication. This new user also purchases a specialized hosting account from a hosting provider. This hosting account is actually a specialized server that initially securely communicates only with this new user.

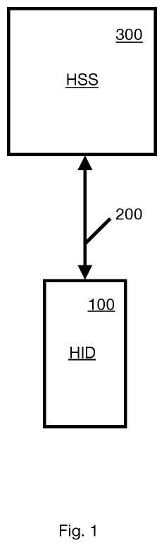

The initial configuration is shown in FIG. 1. FIG. 1 illustrates a schematic diagram of a human interface device 100 (HID) that is in communication with a hosted specialized server 300 (HSS). The HSS is under the command and control of the user of the HID. In one example, a human interface device HID 100 contains specially configured software and keys to communicate with a hosted specialized server HSS 300. In one example, human interface device 100 is a smartphone with software installed for the user to communicate with the server 300. Communication between HID 100 and HSS 300 is indicated by arrowed line 200. In one example, server 300 initially only accepts communications from HID 100. In one example, HID 100 is specialized with keys to be able to control HSS 300.

The new user then is able to “invite” their friends to join. The friends, if they choose to join, are able to download or otherwise subscribe to a social media human interface of their choice. The new user has provided the subscribing friends with special security codes that enable the subscribing friends to join or otherwise connect to the new user's specialized server. Once subscribed, the new user and their subscribed friends are now able to electronically communicate and electronically assemble with each other. In one example, the new user who “owns” the specialized server has the ability to moderate the communications and assembly of the subscribed friends. In this way, there is no global, centralized entity who controls all communications and assembly.

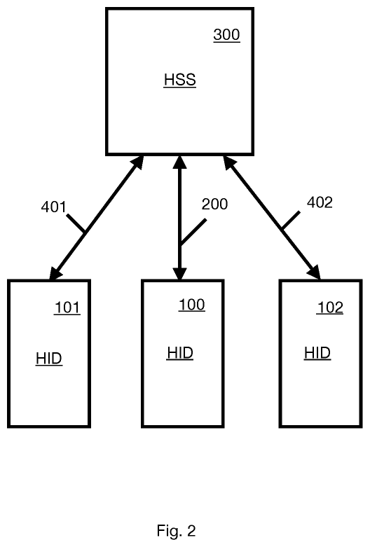

The configuration of friends (or business associates, etc) is shown if FIG. 2. FIG. 2 illustrates a schematic diagram of three HID's that are in communication with an HSS. Communication of two of the HID's with the HSS are under the management of the one HID that commands and controls the HSS. Two additional HID's 101 and 102 are placed in subservient communication with HSS 300. Subservient communication between HID 101 and HSS 300 is indicated by arrowed line 401. Likewise, subservient communication between HID 102 and HSS 300 is indicated by arrowed line 402. In one example, subservient HID's 101 and 102 are able to block undesired communications (or otherwise refuse transmission requests) from HSS 300. In one example, HID's 101 and 102 are able to provide blocking information to HSS 300 for further processing.

In one example, the functionality and appearance of the HID varies between HID's, for example, by using differing social media human interface modules, apps, or skins. For example, the configuration of an HID is achieved through an app that is loaded onto a smartphone. There is more than one app available to the end user to choose the type of human interface that is preferred by the end user. For example, one HID is customized to favor a style desired by some users, another HID is customized to favor a different style that is desired by other users. For example, a user may favor a twitter-style platform. Another user may favor a facebook-style platform. In one example, HID's are customized to align with an affinity group. For example, affinity organizations include industry organizations (IEEE, SPE, UAW), a political rights organizations (AARP, ALCU), animal lovers (SPCA, PETA, animal product suppliers), schools (universities, alumni associations), and so on. In one example, a user has more than one user interface on their physical device.

In further example, a couple of conditions will occur. One, that one or more of the invited friends already has their own subscription with their own paid specialized server. In this situation, for example, the invited friend is connected with one or both of the communication pathways—these being: 1) subscribed to the first new user's server directly and under the moderation of the new user, and 2) subscribed to the first new user through invited friend's own server, effecting a specialized server to specialized server connection. This architecture greatly reduces the fragility of the decentralized network, it actually enables the network to become stronger and stronger as more subscribers are added and more and more subscribers pay for their own hosted specialized server, so they can control the moderation amongst their friends.

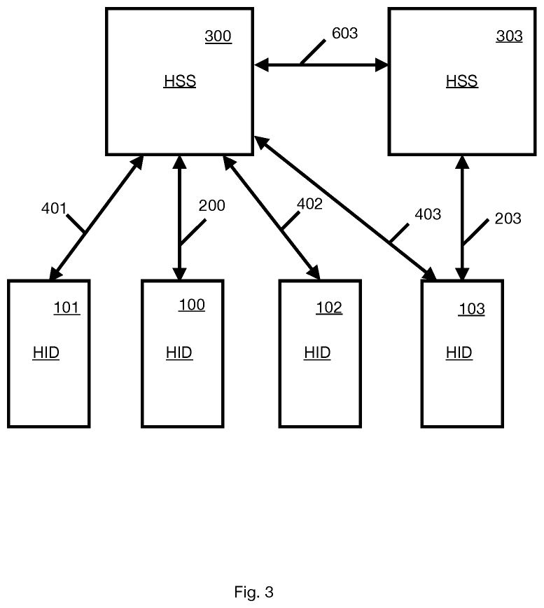

FIG. 3 illustrates a schematic diagram of two HSS's in communication with each other. Three HID's 100 and 101 and 102 are in communication with one HSS 300. One HID 103 is in communication with the other HSS 303. In one example, one HID 103 is in controlling communication with its respective HSS 303 and is also in subservient communication with HSS 300 that is controlled by HID 100. Severs HSS 300 and 303 are in communication with each other, as indicated by communication line 603. In one example, choice of connectivity between two HSS's is based on agreement by the owners of the two HSS's and exchange of authorization keys. In one example, connection 603 is established by key authorizations, based on a registration server (not shown). In one example, choice of connectivity between HSS's is based on traffic patterns. In one example, choice of connectivity between HSS's is based on cost of connection. In one example, choice of connectivity between HSS's is based on hives of HID users with traffic loads between HSS's. In one example, all forms of authorization of connection between two HSS's is under the control and agreement of the owners of the two HSS's. Controlling communication connections are indicated by arrows 200 and 203. Subservient communication connections are indicated by arrows 401 and 402 and 403. In the example, as illustrated, HID 103 has its own corresponding HSS 303 and controls HSS 303 through its controlling communication connection 203. In this example, HID 103 has a second connection into the network. HID 103 has a subservient communication connection 403 to HSS 300, which is controlled by another HID, namely HID 100.

In further example, communications and assembly amongst particular social groups are organically isolated with this disclosed social media communications technology. For instance, followers of a particular religion are able to freely discuss and assemble amongst themselves, without the imposition of censorship or blocking by outside parties. Further, socially distasteful groups or causes become contained within their own specialized servers. For example, a group that promotes beating baby seals with clubs would be very disgusting to a great majority of the e-collective. However, users who are subscribed to the baby seal clubbing specialized server(s) have the choice of dis-engaging from that specialized server. In that situation, those users are still connected to the global collective through their own server and the plethora of servers of their friends. This creates three impacts. One, the baby seal clubbing followers are able to block or censor distractors from their e-communications and e-assembly to the cause. Yet, some of their subscribers may be subscribed to other servers, which do not block communications which are offensive to the baby seal clubbing followers. This is important, because, for the first time, a person is able to subscribe and see two or more conflicting views, without clashing and disruptive communications (shills, etc). This greatly reduces forum arguing. Two, the offensive nature the group, which is not offensive to the members of the group, has a controlled pathway to the global collective. In other words, their “offensive” messaging reaches the global collective through the specialized servers of their subscribers. So, if someone is offended by a communication, they will have received that communication from a friend who is ultimately connected with some friend who is a member of the offensive group. Thus, the offended subscriber, when flagging the communication as offensive, enables any of the specialized servers in the chain to block that chain of communications without desubscribing from their immediate friends. Three, this also enables law enforcement to focus on groups who are engaging in illegal communication or trafficking of illegal materials. For instance, a group who is using their platform to actively traffick drugs will not likely spill over into the global collective. If that group is shut down by a law enforcement entity, it does not affect any of the other forums, nor does it disable the subscribers who are subscribed through other, legal, connections.

In one example, if an interloper, such as a disgruntled hosting company, yanks the specialized server, the subscribers, for the most part, do not lose their web of connections.

Only the bare subscribers, who are not subscribed to any other specialized server, will become isolated. In that unlikely event, that isolated subscriber will simply join one or more other friends (having other, independent, hosted specialized servers) to regain global connection.

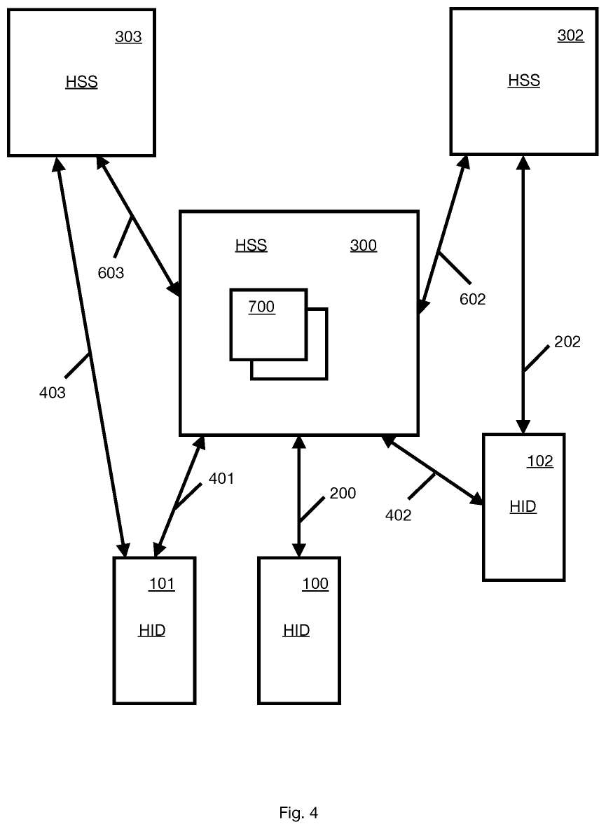

FIG. 4 illustrates a schematic diagram of a network of HSS's and HID's and the routing table/state machine of one HSS. In the example, as illustrated, HSS 300 is shown enlarged and used to disclose details of operation of an HSS and its interactions with its controlling HID 100, its interactions with subservient HID's 101 and 102, and payload communications with HSS 303 and 302. HID 102 is shown in controlling communication with its respective HSS 302. HID 102 is also in subservient connection with HSS 300. HID 101 is shown in subservient connection with HSS 300 and also in subservient connection with HSS 303. Controlling communication connections are shown by arrows 200 and 202. Subservient communication connections are shown by arrows 401 and 402 and 403. Server-to-server payload communications are shown by payload communication connections 602 and 603.

The term “message” can be used as a general term to name a payload of information or instructions that are communicated through the network. “Messages” in this context can include programming instructions, such as applets and extensions for the user interface of the human interface device. In one example, HID 101 has received a message. HID 101 is a subservient human interface device in that HID 101 has no corresponding hosted specialized server (HSS) that HID 101 controls. HID 101, in this example, receives and sends messages to either or both HSS 300 and 303.

Certain conditions occur for the HID 101, depending upon the communications of HSS 300 and 303. This will be herein described as various state conditions.

In a first state, in one example, HSS 303 sends a request to HID 101 to transmit a message (a payload) to HID 101. HID 101 is in an open condition and approves the request from HSS 303. In one example, if the message had already been received then the request is declined. HID 101 receives the message from HSS 303. In one example, the message from HSS 303 includes identification information of the originating HID and originating HSS and identification information of the payload. This message could have originated from the owner of HSS 303 (HID 103, not shown). This message could have originated from some subservient HID that is joined to HSS 303. In simple terms, HID 101 may receive a message from a friend (HSS 303) or from a friend of that friend (subservient HID's joined to HSS 303). Further, HSS 303 is joined to other hosted specialized servers. Thus, the message could have originated from some remote HSS in the network. As a first state, the user of HID 101 has received the message and has no problem with the message content, regardless of its origin.

Continuing with this example, this first received message, although undesired, has already been received and “can not be unseen”. The user of HID 101 is not happy with the received message and desires to limit receiving similar future messages. A collection of alternate states are available to the user of HID 101. A second state is that the user sets HID 101 to block or otherwise decline further messages from that originating HID. A third state is that the user sets HID 101 to block or otherwise decline further messages from that originating HSS. It is not necessary for the user to know who the originator is. A fourth state is that the user informs HID 101 that the message content is undesirable. The content of the undesired message is used to feed a training set for ML or AI recognition of future messages so that future message requests of similar content are marked with an alert or otherwise blocked. It can be appreciated that a type of message (such as third party extensions, advertisements) can be recognized in this manner so that the user will not be further annoyed by future messages of similar type. A fifth state is that the user sets HID 101 to block or otherwise decline further messages from that HSS that is connected to HSS 303. A sixth state is that the user sets HID 101 to block or otherwise decline further messages from any HSS that is connected to HSS 303. In the sixth state, the user of HID 101 only wants to assemble and communicate with friends of HSS 303 (and any other HSS that HID 101 is directly joined as a subservient HID and its controlling HSS, if any). It can be appreciated, in one example, that the states are represented to the user in non-technical terms or imagery to make it easier for the user to choose the restriction options are available.

Continuing with this example, it can be appreciated, that with these state options (some of which are not mutually exclusive) there are situations where communications with a user are only partially blocked. The user of HID 102 provides an example of this feature. HID 102 is joined as a subservient HID to HSS 300. HID 102 also has its own hosting server, HSS 302. In one example, HID 102 communicates with friend owner of HSS 300 and friends of HSS 300, which includes HID 101. The user of HID 102 also communicates with friends and the network as the owner of HSS 302. HID 102, in this example, propagates messages to their HSS 302 that are generally offensive or otherwise undesired by user HID 101. User of HID 101 chooses the third state and/or the fifth state to block communications from HID 102 that are posted through HSS 302. User of HID 102, however, also communicates as a subservient to friend HSS 300 (joined as shown with arrow 402). User of HID 101 has not blocked that communication pathway, as messages from HID 102 sent to friends of HID 100 are acceptable. If user of HID 101 wants to completely block HID 102, then state 2 is chosen.

In one example, the user of HID 101 appreciates the received message and wishes to spread the message to others. The user wants to “promote” the message. In a seventh state, the user of HID 101 re-propagates the message to friend HID 100. This seventh state also applies if the user of HID 101 re-propagates the message to friend HID 103 (not shown). In an eighth state, the user of HID 101 re-propagates the message to friends of HID 100, the other subservient HID's of HSS 300 (for example, HID 102). The eighth state also applies if the user of HID 101 re-propagates to friends of HID 103, the other subservient HID's of HSS 303 (not shown). Thus, the eighth state is re-propagation of messages from a subservient HID to the other subservient HID's to which the subservient HID is joined by one or more common HSS. In a ninth state, the user of HID 101 re-propagates the message to other joined HSS's, for continued propagation through the network. In one example, the user of HID 101 sets the states to always promote messages from a particular originating HID.

Thus, in one example, in summary, one or more of the following states are available to subservient HID's:

State 1: open condition

State 2: block originating HID

State 3: block originating HSS

State 4: learn to block content

State 5: block connecting HSS

State 6: block all connecting HSS

State 7: promote message to controlling HID

State 8: promote message to sibling subservient HID's

State 9: promote message to additional HSS

Turning now to controlling HID's. In one example, the previously described nine states are available to a controlling HID as they are available to a subservient HID. As owner, a controlling HID also has state options associated with controlling the state of message receipt and transmission of the owned HSS. To illustrate, in one example, controlling HID 100 controls its owned HSS 300. State machine 700 contained in HSS 300 processes the various state settings as set by HID 100.

In one example, state settings for HSS 300 are configured by a separate human interface, such as a web page portal or “control panel” for managing and operating HSS 300.

It can be appreciated, in one example, that a given HID is a controlling HID for a given HSS and is also a subservient HID for some other given HSS.

The HSS is exposed to a plethora of communication pathways. In one example, these types of pathways for HSS 300 are summarized as follows:

a) receipt of communications originating from subservient HID's 101 and 102 to HSS 300 and distribution to one or more of the HID's joined to HSS 300 {101->401->300->700->300->200, 402->100, 102}

b) receipt of communications originating from subservient HID's 101 and 102 to HSS 300 and distribution to one or more of joined HSS 302 and 303 {101->401->300->700->300->602, 603->302, 303}

c) receipt of communications originating from a remote HID/HSS “x” passed to HSS 300 from HID's joined to HSS 300 (HID's 100, 101, 102) {x->303->403->101->401->300->700}

d) receipt of communications originating from controlling HID 100 to HSS 300 and distribution to one or more of the HID's joined to HSS 300 {100->200->300->700->401, 402->101, 102}

e) receipt of communications originating from controlling HID 100 to HSS 300 and distribution to one or more of joined HSS 302 and 303 {100->200->300->700->602, 603->302, 303}

f) receipt of communications originating from a remote HID/HSS passed to HSS 300 from controlling HID 100 to HSS 300 {x->100->200->300->700}

g) receipt of communications originating from a joined HSS passed to HSS 300 {302, 303->602, 603->300->700}

h) receipt of communications originating from a remote HID/HSS passed to HSS 300 from a joined HSS {x->302, 303->602, 603->300->700}

i) distribution of communications brokered by routing table 700 of HSS 300 to joined subservient HID's {700->300->401, 402->101, 102}

j) distribution of communications brokered by routing table 700 of HSS 300 to controlling HID 100 {700->300->200->100}

k) distribution of communications brokered by routing table of HSS 300 to joined HSS's {700->300->602, 603->302, 303}

Thus, in one example, in summary, one or more of the following routing states are available to controlling HID's and their respective HSS's:

State 1: open condition

State 2: block originating HID

State 21: moderate originating HID

State 3: block originating HSS

State 31: moderate originating HSS

State 4: learn to block content

State 5: block connecting HSS

State 6: block all connecting HSS

State 7: promote message to controlling HID

State 71: block promotions from originating HID

State 711: moderate promotions from originating HID

State 72: block promotions from originating HSS

State 721: moderate promotions from originating HSS

State 73: block promotions from subservient HID

State 732: moderate promotions from subservient HID

State 8: promote message to sibling subservient HID's

State 81: promote messages to sibling subservient HID's from originating HID

State 82: promote messages to sibling subservient HID's from originating HSS

State 83: promote messages to sibling subservient HID's from subservient HID

State 9: promote message to additional HSS

State 91: promote messages to additional HSS from originating HID

State 92: promote messages to additional HSS from originating HSS

State 93: promote messages to additional HSS from subservient HID

State 100: moderate messages from HSS to other HSS

As can be appreciated, in one example, a communication is moderated by rules (such as a bot run by the server), in one example, a communication is moderated by the user who controls their server.

In one example, HSS 300 processes data for evaluation based on message content, such as training for content blocking. In one example, HSS 300 sends content training for content blocking to another processing center. In one example, content blocking training is processed using inputs from multiple HSS.

Further Examples

In one example, different users use different human interface devices and skin software to access the hosted specialized servers. Multiple types of user interface are used among the user community, even if accessing the same hosted specialized server.

In one example, a user has more than one skin software to use on their human interface device(s) to access the hosted specialized servers.

In one example, provided is distributed control over the right for a group of users to electronically assemble. In one example, provided is distributed control over the right for a group of users to electronically communicate with one another.

In one example, a hosting provider provides hosting accounts to users, enabling a user to have an independent hosted specialized server. In one example, each specialized server provides the regulating functions and state machine for use by the owning user and the users in the community who subscribe to that user's specialized server.

In one example, a social media human interface is software placed or otherwise made available to a user's human interface device. In one example, a social media human interface is software-as-a-service made available to a user.

In one example, a user provides blocking information from their human interface device to a hosted specialized server.

In one example, a human interface device is connected to (or otherwise in authorized communication with) a plurality of hosted specialized servers.

In one example, a hosted specialized server is in authorized communication with one or more other hosted specialized servers.

In one example, a human interface device (including the social media human interface software) is in subservient communication with one or more hosted specialized servers. Regulation of communications are controlled or otherwise overseen by the hosted specialized servers.

In one example, a human interface device (including the social media human interface software) is in controlling communication with a hosted specialized server. Regulation of communications and regulation settings for the hosted specialized server are set or otherwise overseen by user through their controlling human interface device.

In one example, provided is a method for free exercise of speech in an electronic community network.

In one example, provided is a method for free exercise of assembly in an electronic community network.

In one example, provided is a method for reducing disruptive communications in an electronically gathered community, where the electronically gathered community is contained within a global collective of people who are in electronic communication.

In one example, provided is a method for self moderating communications in an electronically-enabled global collective.

In one example, provided is a method for electronically self-isolating communications of affinity groups.

In one example, provided is a method for self-assembly of electronic communications infrastructure used by affinity groups. In one example, each user participates in the physical construction of a self-organizing map of a physical communications network, for example, through the purchasing of rights to hosted specialized servers and the subscription of users to those various independent hosted specialized servers.

In one example, provided is a state machine that is manifested in a physical network of computers and communication devices (such as “the internet”), including a plurality of human interface devices and a plurality of separately controlled hosted specialized servers. In further example, the human interface devices use a plurality of social media human interface software, or skins, so that each user is not necessarily using the same interface appearance to the servers. One or more of the human interface devices (an associated interface skin) is subservient to the hosted specialized server(s). For a given hosted specialized server, a particular human interface device controls or otherwise regulates communications that go through the server.

In one example, the state machine provides at least a subset of the following states for control by the human interface device: open communication condition, block communications from an originating HID, block communications from originating HSS, training mode—learn to block content, block communications from a connecting HSS, block communications from all connecting HSS, promote a message to the controlling HID, promote a message to sibling subservient HID's, promote a message to additional HSS'.

In further example, the state machine provides at least the following states for control by the human interface device: block communications from an originating HID, and block communications from originating HSS.

In further example, the state machine provides at least the following state for control by the human interface device: training mode—learn to block content.

In further example, the state machine provides at least the following states for control by the human interface device: block communications from a connecting HSS, block communications from all connecting HSS.

In one example, the state machine provides at least a subset of the following states for control by the hosted specialized server: open communication condition, block communications from an originating HID, moderate communications from an originating HID, block communications from originating HSS, moderate communications from an originating HSS, training mode—learn to block content, block communications from a connecting HSS, block communications from all connecting HSS, promote a message to the controlling HID, block promotions from an originating HID, moderate promotions from originating HID, block promotions from originating HSS, moderate promotions from originating HSS, block promotions from subservient HID, moderate promotions from subservient HID, promote a message to sibling subservient HID's, promote messages to sibling subservient HID's from originating HID, promote messages to sibling subservient HID's from originating HSS, promote messages to sibling subservient HID's from subservient HID, promote a message to additional HSS', promote messages to additional HSS from originating HID, promote messages to additional HSS from originating HSS, promote messages to additional HSS from subservient HID, moderate messages from HSS to other HSS.

In further example, the state machine provides at least the following states for control by the hosted specialized server: training mode—learn to block content.

In further example, the state machine provides at least one of the following states for control by the hosted specialized server: moderate communications from an originating HID, moderate communications from an originating HSS, block promotions from an originating HID.

In one example. provided is a method for a social media user to subscribe with ability to see two or more conflicting views on a topic of interest, independent of distracting or harassing communications.

In one example, provided is a distributed network of servers, independently managed from each other, having specialized capability to receive, process, and forward social media moderating and censoring commands. In one example, the moderating and censoring commands are processed by a state machine contained in the special capability servers. In one example, individual users are able to subscribe to more than one server. In one example, individual users are able to choose among a plurality of separate human interfaces or “skins” or apps to meet their social media interface preferences.

In one example, the requirements for the invention are solved by a computer program. The computer program product comprises instructions which, when the program is executed by a computer, cause the computer to carry out the steps of the computer-assisted method as described above.

In one example, the above-mentioned requirements for the invention are also solved by a computer-readable data carrier. The computer-readable data carrier has stored thereon the computer program as described above.

In one example, the above-mentioned requirements for the invention are also solved by a computer-assisted system for generating training data to be used in machine learning models.

Even if some of the aspects described above have been described in reference to the computer-assisted method, these aspects may also apply to the computer-assisted system. Likewise, the aspects described above in relation to the computer-assisted system may be applicable in a corresponding manner to the computer-assisted method.

### INDUSTRIAL APPLICABILITY

As can be appreciated, the workflow steps herein described are reduced to practice through computer code that is executed on one or more computing devices. In one example, a virtual workstation is constructed to operate on a computing device that includes a display that also receives hand input from the user. In one example, a virtual workstation is a human interface device portraying a social media platform. In one example, content moderation requests from human interfaces are used in the construction of training sets and resulting trained models. Multiple virtual workstations contribute to pool the identifiers, training sets, and/or resulting models through one or more collecting computing devices, such as servers and neural processing centers. In a crowd sourced application, identifiers from varied sources are used in the construction of training sets and resulting trained models. In a crowd sourced application, the associations between identifiers, training sets, and/or resulting models are available for parallel-cascading training and/or execution of resulting trained models.

Physical Parameters.

It can be appreciated that the aspects of the invention are expressed in computer code used to configure computing devices to operate as hosting servers having the operation functions and gatekeeper functions required to carry out the intent of the present invention. It can also be appreciated that aspects of the invention expressed in computer code are placed in tangible form, such as a computer-readable data carrier, such as disk drives, electronic memory, and the like. It can be further appreciated that networking hardware and communications lines (including radio frequency transceivers) connect to physical computing devices in order to transmit and receive actuation orders to and from physical human interface computing devices and servers hosting the specialized servers that are executing the instruction sets and computer code required to carry out the intent of the present invention.

It is clear to a person skilled in the art that the statements set forth herein under use of hardware circuits, software means or a combination thereof may be implemented. The software means can be related to programmed microprocessors or a general computer, an ASIC (Application Specific Integrated Circuit) and/or DSPs (Digital Signal Processors). For example, the common computing infrastructure, user (equipment), computer-assisted method and computer-assisted system may be implemented partially as a computer, a logical circuit, an FPGA (Field Programmable Gate Array), a processor (for example, a microprocessor, microcontroller (μC) or an array processor)/a core/a CPU (Central Processing Unit), an FPU (Floating Point Unit), NPU (Numeric Processing Unit), an ALU (Arithmetic Logical Unit), a Coprocessor (further microprocessor for supporting a main processor (CPU)), a GPGPU (General Purpose Computation on Graphics Processing Unit), a multi-core processor (for parallel computing, such as simultaneously performing arithmetic operations on multiple main processor(s) and/or graphical processor(s)) or a DSP.

It is further clear to the person skilled in the art that even if the herein-described details will be described in terms of a method, these details may also be implemented or realized in a suitable device, a computer processor or a memory connected to a processor, wherein the memory can be provided with one or more programs that perform the method, when executed by the processor. Therefore, methods like swapping and paging can be deployed.

Conclusion.

Although the present invention is described herein with reference to a specific preferred embodiment(s), many modifications and variations therein will readily occur to those with ordinary skill in the art. Accordingly, all such variations and modifications are included within the intended scope of the present invention as defined by the reference numerals used.

From the description contained herein, the features of any of the examples, especially as set forth in the claims, can be combined with each other in any meaningful manner to form further examples and/or embodiments.

The foregoing description is presented for purposes of illustration and description, and is not intended to limit the invention to the forms disclosed herein. Consequently, variations and modifications commensurate with the above teachings and the teaching of the relevant art are within the spirit of the invention. Such variations will readily suggest themselves to those skilled in the relevant structural or mechanical art. Further, the embodiments described are also intended to enable others skilled in the art to utilize the invention and such or other embodiments and with various modifications required by the particular applications or uses of the invention.

1. A computer-assisted method for reducing disruptive communications in electronically-gathered user communities who are a sub-set of a global collective of users, comprising:
hosting a community of users on a server controlled by a user;
regulating communications from each of the community of users, based on regulating conditions;
receiving regulating conditions sent by each of the community of users;
setting regulating conditions based on the received regulating conditions;
connecting the server to other servers performing the like functions; and
forwarding regulating conditions to the other servers.

2. The computer-assisted method of claim 1 wherein a user in the community of users connects to a plurality of independently controlled servers performing the like functions.

3. A computer program, characterized in that the computer program product comprises instructions which, when the program is executed by a computer, cause the computer to:
regulate communications from a plurality of subservient human interface devices to other subservient human interface devices, forming a hosted specialized server;
regulate communications to and from other hosted specialized servers regulating communications from another plurality of subservient human interface devices;
receive regulating conditions from subservient human interface devices for processing or forwarding communications to other hosted specialized servers; and
receive regulating conditions from other hosted specialized servers for processing or forwarding communications to other hosted specialized servers.

4. The computer program of claim 3, comprising a state machine a state machine that is manifested in a physical network of computers and communication devices, including a plurality of human interface devices (HID) and a plurality of separately controlled hosted specialized servers (HSS), the state machine providing at least a subset of the following states for control by the human interface device: open communication condition, block communications from an originating HID, block communications from originating HSS, training mode—learn to block content, block communications from a connecting HSS, block communications from all connecting HSS, promote a message to the controlling HID, promote a message to sibling subservient HID's, and promote a message to additional HSS'.

5. The computer program of claim 3, comprising a state machine a state machine that is manifested in a physical network of computers and communication devices, including a plurality of human interface devices (HID) and a plurality of separately controlled hosted specialized servers (HSS), the state machine providing at least a subset of the following states for control by the hosted specialized server: open communication condition, block communications from an originating HID, moderate communications from an originating HID, block communications from originating HSS, moderate communications from an originating HSS, training mode—learn to block content, block communications from a connecting HSS, block communications from all connecting HSS, promote a message to the controlling HID, block promotions from an originating HID, moderate promotions from originating HID, block promotions from originating HSS, moderate promotions from originating HSS, block promotions from subservient HID, moderate promotions from subservient HID, promote a message to sibling subservient HID's, promote messages to sibling subservient HID's from originating HID, promote messages to sibling subservient HID's from originating HSS, promote messages to sibling subservient HID's from subservient HID, promote a message to additional HSS', promote messages to additional HSS from originating HID, promote messages to additional HSS from originating HSS, promote messages to additional HSS from subservient HID, and moderate messages from HSS to other HSS.

6. A computer-assisted system for delivering communications within a collective of users, the system is configured to:
regulate communications from a plurality of subservient human interface devices to other subservient human interface devices, forming a hosted specialized server;
regulate communications to and from other hosted specialized servers regulating communications from another plurality of subservient human interface devices;
receive regulating conditions from subservient human interface devices for processing or forwarding communications to other hosted specialized servers; and
receive regulating conditions from other hosted specialized servers for processing or forwarding communications to other hosted specialized servers.

7. The computer-assisted system of claim 6, comprising a state machine a state machine that is manifested in a physical network of computers and communication devices, including a plurality of human interface devices (HID) and a plurality of separately controlled hosted specialized servers (HSS), the state machine providing at least a subset of the following states for control by the human interface device: open communication condition, block communications from an originating HID, block communications from originating HSS, training mode—learn to block content, block communications from a connecting HSS, block communications from all connecting HSS, promote a message to the controlling HID, promote a message to sibling subservient HID's, and promote a message to additional HSS'.

8. The computer-assisted system of claim 6, comprising a state machine a state machine that is manifested in a physical network of computers and communication devices, including a plurality of human interface devices (HID) and a plurality of separately controlled hosted specialized servers (HSS), the state machine providing at least a subset of the following states for control by the hosted specialized server: open communication condition, block communications from an originating HID, moderate communications from an originating HID, block communications from originating HSS, moderate communications from an originating HSS, training mode—learn to block content, block communications from a connecting HSS, block communications from all connecting HSS, promote a message to the controlling HID, block promotions from an originating HID, moderate promotions from originating HID, block promotions from originating HSS, moderate promotions from originating HSS, block promotions from subservient HID, moderate promotions from subservient HID, promote a message to sibling subservient HID's, promote messages to sibling subservient HID's from originating HID, promote messages to sibling subservient HID's from originating HSS, promote messages to sibling subservient HID's from subservient HID, promote a message to additional HSS', promote messages to additional HSS from originating HID, promote messages to additional HSS from originating HSS, promote messages to additional HSS from subservient HID, and moderate messages from HSS to other HSS.
